(19) United States
(12) Patent Application Publication
(10) Pub. No.: US 2013/0087364 A1
(43) Pub. Date: Apr. 11, 2013

(54) Film Conductor for Flat Cells and Method for Producing Same

(71) Applicants: Frank Blome, Fichtenwalde (DE); Roland Weixler, Kempten (DE)

(72) Inventors: Frank Blome, Fichtenwalde (DE); Roland Weixler, Kempten (DE)

(73) Assignee: Daimler AG, Stuggart (DE)

(21) Appl. No.: 13/640,606

(22) PCT Filed: Apr. 12, 2011
(86) PCT No.: PCT/EP2011/001805

§ 371 Date: Nov. 8, 2012

(30) Foreign Application Priority Data
Apr. 12, 2010 (DE) 10 2010 014 700.1

(51) Int. Cl. H01B 1/00; H01B 19/00

(52) U.S. Cl. CPC H01B 1/00; H01B 19/00
USPC 174/126.2; 174/126.1; 29/825

(57) ABSTRACT

A foil conductor for flat cells includes a contact zone for contact with further cells or busbars, an adhesion zone for adhesive bonding with a packaging foil of a cell, and a connection zone for connection to an electrode foil within the cell. At least two of the zones have a surface composition differing from each other.

### BACKGROUND AND SUMMARY OF THE INVENTION

Exemplary embodiments of the present invention relate to foil conductors for flat cells, in particular foil conductors for lithium-ion cells. Such cells consist substantially of flat electrodes or electrode stacks arranged in an electrolyte, wherein the negative pole (anode) and the positive pole (cathode) are separated by a separator layer permeable to Li+ ions. The cell is outwardly insulated and sealed in relation to the neighboring cell and in relation to the environment with an aluminum-encased packaging foil.

Conductors or conductor lugs connected to the electrodes are fed outwardly out of the inside of the cell in order to tap the potential arising between the different electrodes or electrode stacks. Outside of the cell the conductor lugs can then be connected to further cells or to a busbar.

Metal strips or metal foils are normally used as conductors, wherein a nickel plated copper sheet is generally used for the negative conductor and an aluminum sheet is used for the positive conductor.

The conductors must thereby fulfill a plurality of functions:

On the one hand they must facilitate, in their so-called contact zone projecting outwardly out of the cell, permanent electrical contact with a busbar or another cell. There is the particular problem with the positive conductor that soldering on aluminum is not possible or is only possible with great flux means due to the natural oxide skin of the aluminum and is not very suitable for the connection of thin conductors directly neighboring temperature-sensitive plastic components.

Screwing the conductors requires additional components (screws, clamping and thread plates), which results in additional weight on the sensitive foil conductors and increased manufacturing costs.

Ultrasonic weld joints in the contact zone have the disadvantage that the region, in which the conductor passes through the packaging foil and is adhesively bonded to it (adhesion zone), can be previously damaged through the vibration energy thereby introduced. Besides, the region of the conductor that is connected to the electrodes inside the cell (connection zone) can be damaged by the ultrasonic welding process, whereby the quality of the electrical connection between the conductor and electrodes is impaired.

Furthermore, the conductors must be configured so that the cell is also permanently sealed in the region of the aforementioned adhesion zone. The sealing of the foil conductors with the outer shell of the cell is carried out by means of a thermal melt/adhesive bonding process in the prior art. The conductors are thereby frequently reinforced with a plastic film or similar insulation material in the adhesion zone in order to improve the connection and to guarantee the electrical insulation in relation to the metal layer in the encased packaging foil. The adhesive connection of the untreated aluminum conductor can easily be chemically infiltrated and thus constitutes a permanent leakage risk.

Exemplary embodiments of the present invention provide an improved foil conductor that can be easily electrically contacted and with which cells can be realized with increased sealing.

The foil conductor for flat cells according to the invention comprises a contact zone for contact with further cells or busbars, an adhesion zone for adhesive bonding with a packaging foil of a cell and a connection zone for connection to an electrode foil within the cell. According to the invention at least two of the zones thereby comprise a surface composition deviating from each other. In other words the surface structure, for example of a strip-form foil conductor, changes in the longitudinal direction of the strip. It can thereby be taken into account that the requirements upon the surface of the foil conductor also differ in dependence upon the respective position on the conductor.

The foil conductor can comprise, as a positive conductor, for example an aluminum base structure and the adhesion zone can be provided with an adhesion base/conversion layer.

This solves the problems associated with industrially produced aluminum foils and strips having a natural oxide skin, in which moisture, dirt, oils and greases are securely held. The natural oxide skin is unsuitable as a corrosion protection and also as an adhesion base for an adhesive bonding connection, in particular because it is precisely through this natural oxide skin that an organic coating is corrosively infiltrated. In order to produce an industrially adhesive surface it is thus advantageous to initially chemically remove the natural oxide skin, after which an adhesion base and a conversion layer can be formed in a controlled manner on the cleaned surface without delay. Trivalent and hexavalent chromic acid solutions, chromium-free solutions on a titanium or zirconium base and anodically produced oxide layers (anodizing, hard anodizing) can be used as adhesion bases. The use of trivalent chromium thereby offers the following advantages:
good solubility in acidic aqueous environment, in which conversion layers are generally formed on aluminum
the reaction products (chromium(III) oxides) on the surface are inert and offer a permanent protection
no risk to health.

The aforementioned adhesive layers are preferably immediately covered in a bathing process with a polymer layer as a pre-sealing means. The layer can also be formed as a foil, in particular as a foil melted directly after the adhesive coating. In the latter case the use of a primer is not necessary. The polymer layer protects the adhesive surface of the conductor from subsequent contamination through handling works and can subsequently be thermally welded directly to the packaging foil. Instead of a polymer layer, other strips that are provided with, for example, primers are in particular also possible, in particular also fabric tapes.

In those cases in which the foil conductor also comprises a copper base structure with a nickel-plated surface, thus in general being used as a negative conductor, it can be advantageous for the adhesion zone to have a roughened surface. Advantageous roughening depths lie in the range of 5-40 μm. The rough surface can be produced through chemical or mechanical processes such as, for example, grinding or irradiation, wherein when using an irradiation method the mechanical sensitivity of the foils in question is to be considered.

The electrical contract with busbars or for serial connections of cells can be simplified in that, if the foil conductor comprises an aluminum base structure, the contact zone is provided with a solderable coating, which can contain in particular nickel, tin, copper or silver. The coating can thereby preferably be carried out with the pure material. However, different layer sequences such as for example a first layer of Ni and a second layer of Sn can be applied.

Particularly in the serial arrangement of cells one behind the other, the positive conductor comprising aluminum and the negative conductor comprising nickel-plated copper must be connected to each other. A soldered connection with the two conductor materials is possible through the aforementioned solderable coating of the positive conductor in the contact zone preferably with nickel. In addition, measurement or connection lines consisting of copper can be directly soldered to the thus coated foil conductor. Corresponding to the solder process requirements, as already mentioned, other or additional solderable coatings (e.g. tin, copper, silver) can be applied in part. The coating can for example be carried out through individual or strip galvanization. For partial coating as a strip material, immersion depth, brush, jet-plating or tape methods can be used.

Within the scope of an immersion depth method, for example, the starting material of the later foil conductor can be guided, suspended in the region of the later connection zone, through the respective immersion baths. In particular, initially, the adhesion/conversion layer can be produced in the regions provided for the adhesion and contact zone. After sealing of the later adhesion zone, the adhesion/conversion layer can be removed in the region provided for the contact zone, for example through etching, after which an application of a solderable layer can take place in this zone. Neither the later connection zone found outside of the immersion bath nor the sealed later adhesion zone are affected by this.

The solderable coating of the conductor described above is conceivable, besides the aforementioned application for flat cells, also for round cells. Targeted spot plating on the aluminum can of the cell can thereby be carried out in order to produce a region with a solderable contact zone for the soldering of conductor lugs.

In a further embodiment of the invention the foil conductor for flat cells can have a rectangular cross-section modified in that the short sides of the rectangles are formed as wedges or tongues extending outwards. This deviation from the pure rectangular form allows the polymer layer surrounding the conductor and/or the packaging foil adhesively bonded to it to follow the conductor geometry in an improved manner and surround it in a more sealed way in comparison with the prior art.

In other words, the cross-sectional geometry of the conductor can be adapted in an improved manner to the course of a foil surrounding it than would be the case with a strictly rectangular design of the conductor cross-section, whereby an improved sealing of the cell can be achieved in the conductor region. Through the aforementioned measure it is further possible to select the dimensions of the conductors from a further region, in particular also to use thicker conductors. This also benefits the mechanical stability of the conductors. A possible production process for the desired form consists of a stamping process after the punching out of the foil conductor from a strip material.

It is understood that the modifications of the conductor cross-section described above can take place independently of the formation of surface regions of the conductor with different composition.

A method for producing a foil conductor according to the invention for flat cells produces, on a flat metallic base structure, at least two zones with a surface composition differing from each other and can contain in particular the following steps:
punching-out of the aluminum strip material
degreasing
removal of the oxide skin
coating of the adhesion zone with an adhesion base/conversion layer.

In addition or alternatively, the method can comprise the following steps:
a stamping step for producing a suitable edge structure
pre-sealing of the adhesion zone
etching of the contact zone
metallization of the contact zone with a solderable surface.

As a result of the different surface compositions and/or coatings of the contact zone and/or the adhesion zone and/or the connection zone according to the invention it is possible to select a favorable connecting method for the respective zone, wherein at best negligible stress is placed on the already existing connections of the foil conductor. The quality and stability of an already existing connection of a foil conductor with an electrode foil and/or contacting with a further foil conductor and/or sealing of a foil conductor through the packaging foil can also be at least extensively ensured after a subsequent further connection method.

In particular the connection zone can be optimized for an ultrasonic welding process, the contact zone for a soldering and/or welding process, in particular a laser welding process, and the adhesion zone for a sealing adhesion.

### BRIEF DESCRIPTION OF THE DRAWING FIGURES

The invention will be explained in greater detail below by reference to the drawing, in which:

FIGS. 1A and 1B illustrate, a side and cross-sectional view of a flat cell with foil conductors;

FIGS. 2A and 2B illustrate a cut-out enlargement of FIGS. 1A and 1B;

FIG. 3 illustrates implementation of a foil conductor through a flat cell according to the prior art;

FIG. 4 illustrates a first perspective view of a modified foil conductor with passage through the packaging foil of a flat cell;

FIG. 5 illustrates a variant to the illustration shown in FIG. 4; and

FIG. 6 illustrates a round cell with modified surface structure as a further variant of the invention.

### DETAILED DESCRIPTION

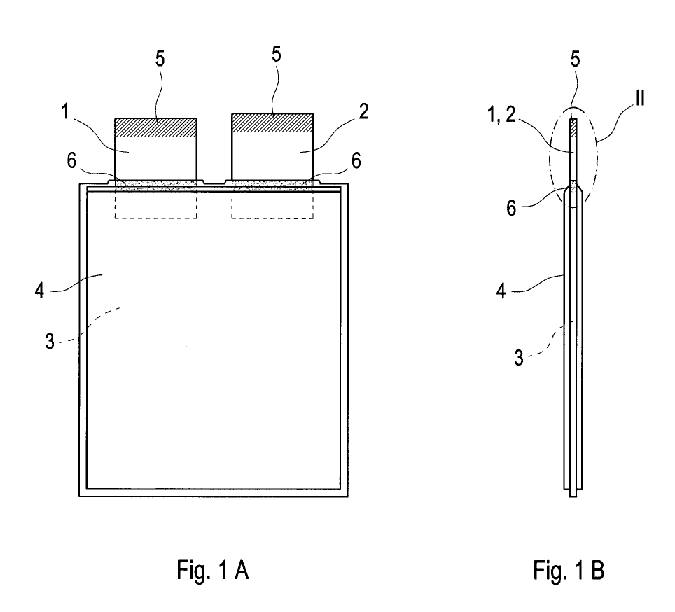

FIGS. 1A and 1B illustrate a top view and a side sectional illustration of a flat cell that is provided with the foil conductors 1 and 2 configured according to the invention. The foil conductors 1 and 2, from which the conductor 1 is configured as a negative conductor from nickel-plated copper sheet and the conductor 2 as a positive conductor from aluminum sheet, pass through the aluminum-encased packaging foil 4 in the adhesion zone 6 and are connected inside the flat cell in the connection zone 7 to the electrode foil stacks 3 (not shown in more detail in FIGS. 1A and 1B). Outside of the flat cell the conductors comprise the contact zone 5 for contacting the conductors 1 and 2 to further cells or busbars. The positive conductor 2 which, as already explained, is formed from an aluminum sheet, thereby comprises in its contact zone 5, shown hatched-in, a solderable coating on the aluminum base structure so that the contact zone 5 of the positive conductor 2 is suited for simple soldering to conductors such as, for example, power or also measurement lines. The solderable coating can thereby contain nickel, tin or silver. A material system of a nickel layer of a thickness of 3-10 μm is thereby particularly preferable. Alternatively a sequence of layers from a first nickel layer of a thickness of 3-10 μm and a tin layer applied thereto with a thickness of 2-6 μm can be used. The second variant is thereby characterised by better soldering properties, but it requires greater resources in production due to the two-stage process.

In the adhesion zone 6 shown in points, the foil conductor 2 is provided with an adhesion base/conversion layer that improves the material connection between the aluminum-encased packaging foil 4 and the foil conductor 2. The aforementioned adhesion base/conversion layer thereby comprises a Crlll containing passivation. FIGS. 1A and 1B do not show an additional polymer layer, which can be formed, for example, as a polymer film and which is arranged on the adhesion base/conversion layer. On its side facing away from the adhesion base/conversion layer, the polymer layer is adhesively bonded to the aluminum-encased packaging foil 4.

The adhesive bonding of the negative conductor 1 to the aluminum-encased packaging foil 4 is improved in the example shown in that the negative conductor 1 is provided in its adhesion zone 6 with a roughened surface, whereby likewise the adhesion flow between the surface of the conductor 1 and the packaging foil 4 is improved.

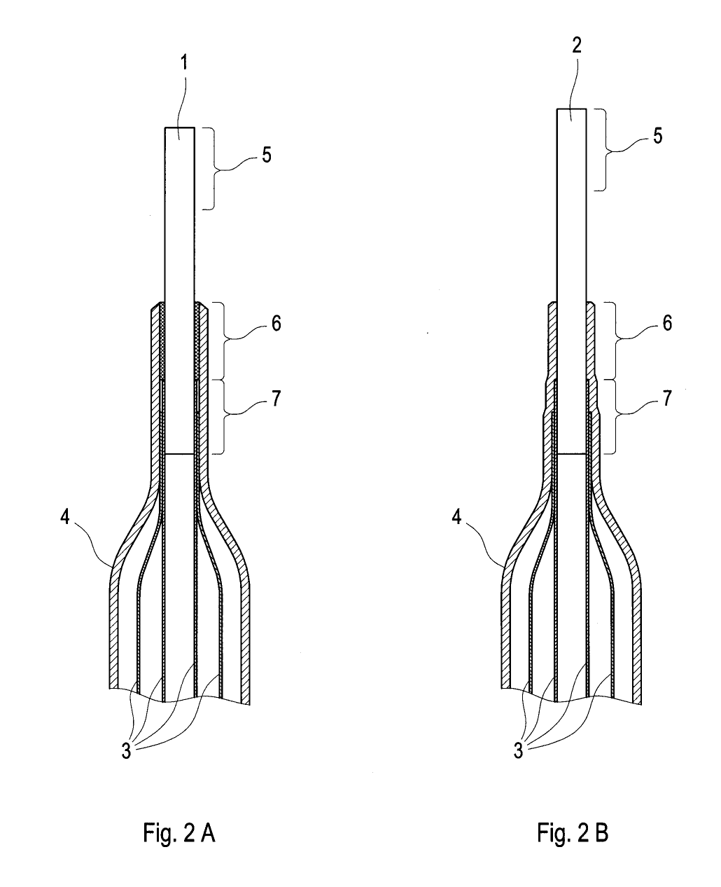

FIGS. 2A and 2B show for further illustration once again the region shown in dotted lines in FIG. 1B as a cut-out enlargement with reference numerals corresponding to FIG. 1. FIG. 2A thereby illustrates a conductor 1 with a pre-sealing layer 9, whereas FIG. 2B illustrates a conductor 2 without a pre-sealing layer.

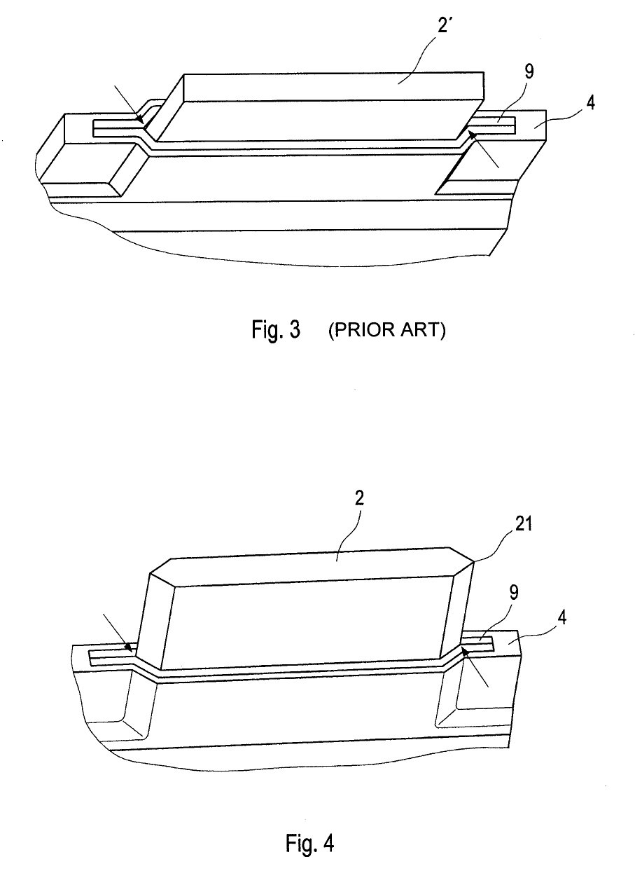

FIG. 3 shows the implementation of a positive conductor 2′ according to the prior art through a packaging foil 4 of a flat cell. The positive conductor 2′ is thereby surrounded by a pre-sealing layer 9 which is arranged in the region of the passage of the positive conductor 2′ through the packaging foil 4. It is easy to see in FIG. 3 the practically unavoidable gap between the pre-sealing layer 9 and the side end faces of the conductor 2′. At the points highlighted with the arrows a reliable sealing of the flat cell in relation to the environment is practically impossible.

FIG. 4 shows a solution according to the invention for geometric design of the conductor 2, through which this problem is overcome. As can be seen from FIG. 4, the conductor 2 is designed in such a way that its cross-section differs from the rectangular form. In particular, the cross-section of the conductor 2 is formed in such a way that the short sides of the rectangle are provided with wedge-form or tongue-form projections 21. This measure has the effect that the pre-sealing layer 9 shown in FIG. 4, which can be formed for example as a polymer film, is laid along the whole conductor cross-section practically without interruption and thus guarantees, in association with the packaging foil 4, a reliable sealing of the inside of the flat cell in relation to the environment. Other forms for the design of the region 21 are also possible. However, it is advantageous in any case if the form of the region 21 is adapted to the conceived form of a surrounding foil. For example, a flat lens-form cross-section of the conductor 2 could also be considered.

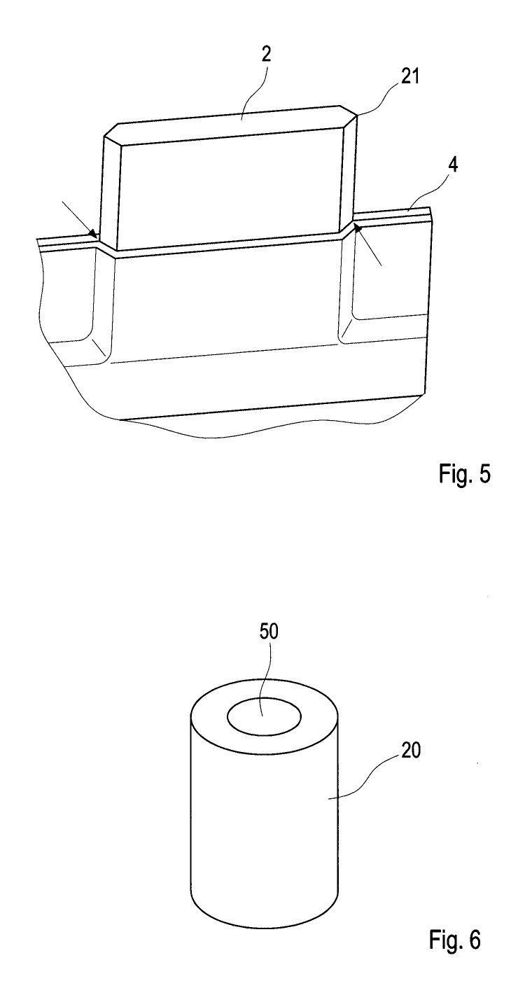

FIG. 5 shows a variant of FIG. 4, wherein the packaging film 4 is directly adhesively bonded to the conductor 2. Otherwise the variant of FIG. 5 corresponds to the embodiment shown in FIG. 4.

FIG. 6 shows a further possibility for improving the contact of battery cells, here of round cells. The aluminum cell can 20, shown in FIG. 6, is provided on its upper end face with a metallization layer 50, through which a solderable surface is created. It is possible to produce such an easily contactable cell can, for example, through an impact extrusion process. The region 50 to be metalized can subsequently be degreased in part to remove oils, greases and dirt and also etched in part, whereby the natural oxide skin is removed and a defined base surface is produced. After a single or double zincate etching of the region 50, the galvanic metallization thereof takes place with the desired solderable surface. The metallization can thereby be carried out in the manner indicated above using the solution for flat cells.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-21. (canceled)

22. A foil conductor for flat cells, comprising:
a contact zone configured for contact with further cells or busbars;
an adhesion zone configured for adhesive bonding with a packaging foil of a cell; and
a connection zone configured for connection to an electrode foil within the cell,
wherein at least two of the zones have a surface composition that are different from each other.

23. The foil conductor according to claim 22, wherein the foil conductor comprises an aluminium base structure and the adhesion zone comprises an adhesion base/conversion layer.

24. The foil conductor according to claim 23, wherein there is no natural aluminium oxide skin between the adhesion base/conversion layer of the adhesion zone and the aluminum base structure.

25. The foil conductor according to claim 23, wherein a polymer layer is arranged on the adhesion base/conversion layer of the adhesion zone.

26. The foil conductor according to claim 22, wherein the foil conductor comprises an aluminium base structure and the contact zone comprises a solderable coating.

27. The foil conductor according to claim 26, wherein the solderable coating contains nickel, tin, copper or silver.

28. The foil conductor according to claim 22, wherein the foil conductor comprises a copper base structure.

29. The foil conductor according to claim 28, wherein the adhesion zone has a roughened surface.

30. The foil conductor according to claim 28, wherein the foil conductor comprises a nickel-plated surface.

31. The foil conductor according to claim 22, wherein the surface or coating structure of the contact zone is conditioned for a soldering or welding process.

32. The foil conductor according to claim 22, wherein a surface or coating structure of the connecting zone is conditioned for an ultrasonic welding process.

33. The foil conductor according to claim 22, wherein the foil conductor has a rectangular cross-section with short sides of the rectangles extending outwardly in a manner of a wedge or tongue.

34. A method for producing a foil conductor for flat cells, comprising:
forming a contact zone configured for contact with further cells or busbars;
forming an adhesion zone configured for adhesive bonding with a packaging foil of a cell; and
forming a connection zone configured for connection to an electrode foil within the cell,
wherein at least two zones have a surface composition different from each other are produced on a flat metal base structure.

35. The method for producing a foil conductor for flat cells according to claim 34, wherein a surface of the connection zone is conditioned for an ultrasonic welding process.

36. The method for producing a foil conductor for flat cells according to claim 35, wherein the surface of the connection zone is conditioned for the surface structure or the coating of the contact zone for a soldering or welding process.

37. The method according to claim 34, further comprising:
punching out from aluminum strip material,
degreasing; and
removing a natural oxide skin.

38. The method according to claim 34, further comprising:
coating of the adhesion zone with an adhesion base/conversion layer.

39. The method according to claim 38, further comprising:
pre-sealing of the adhesion zone.

40. The method according to claim 34, further comprising:
etching of the contact zone.

41. The method according to claim 40, further comprising:
metallization of the contact zone with a solderable surface.

42. The method according to claim 34, further comprising:
a stamping stage.
